(19) United States
(12) Patent Application Publication
(10) Pub. No.: US 2025/0155330 A1
(43) Pub. Date: May 15, 2025

(54) PARTICLE MONITORING SYSTEM AND PROCESS FOR MONITORING PARTICLES IN A SAMPLE FLUID

(71) Applicants: MERCK PATENT GMBH, Darmstadt (DE); MBV AG, Staefa (CH)

(72) Inventors: Anne-Grit KLEES, Darmstadt (DE); Tony ANCRUM, Nottingham (GB); Corina KELLER, Staefa (CH); Roland DURNER, Staefa (CH); Andy ZINGRE, Staefa (CH)

(73) Assignees: MERCK PATENT GMBH, Darmstadt (DE); MBV AG, Staefa (CH)

(21) Appl. No.: 18/840,118

(22) PCT Filed: Feb. 20, 2023
(86) PCT No.: PCT/EP2023/054123

§ 371 Date: Aug. 21, 2024

(30) Foreign Application Priority Data
Feb. 22, 2022 (EP) 22305191.3

(51) Int. Cl. G01N 1/22; G01N 1/02; G01N 15/00

(52) U.S. Cl. CPC G01N 1/2273; G01N 15/00; G01N 2001/021; G01N 2001/2297; G01N 2015/0046

(57) ABSTRACT

The present invention relates to a particle monitoring system and to a process of monitoring particles in a sample fluid.

### TECHNICAL FIELD

The present invention relates to a particle monitoring system and to a process of monitoring particles in a sample fluid.

### BACKGROUND

The monitoring of sample fluids, either of liquids or more commonly of gases like air, is frequently performed for the purpose of evaluating contaminants, for classification and monitoring purposes, in a range of cleanroom and manufacturing environments requiring low levels of particles, such as cleanroom environments for electronics manufacturing and aseptic environments for manufacturing pharmaceutical and biological products, such as sterile medicinal products.

For the purpose of monitoring air in such a context, particle monitoring systems are known and comprise microbial or active air samplers and particle counters. Microbial or active air samplers and airborne particle counters are beneficial because they allow a user to sample a quantitative amount of air and to determine the risk for contamination (microbial flora) to sterile products in a surrounding environment.

An example of a microbial air sampler and method for sampling, detecting and/or characterizing particles, for example, via collection, growth and analysis of viable biological particles such as microorganisms is disclosed in EP 0 964 240 A1. This device includes an integrated sampler and impact surface, such as the receiving surface of a growth media, for collecting biological particles. The collected particles are then typically incubated to grow living particles and are then analyzed by different techniques including naked eyes inspection, microscopy, fluorescence or auto-fluorescence, ATP (adenosine triphosphate) detection or others.

A particle counter as the other type of particle monitoring device typically pumps the gas to be monitored through a measuring system. A laser beam is directed into the gas flow and particles crossing the laser beam will create signals that are detected by a photomultiplier. The output of the photomultiplier has several amplifiers with different gain stages that allow a discrimination of particle number and particle sizing based on the evaluation of the signals, more specifically of the amplitudes of the signals.

The present invention pertains to particle monitoring systems where the sampling section for performing a sampling process on a sample fluid, preferably a gas, such as air, comprises either a particle collector or a particle counter, or one where the sampling section comprises a combination of a particle collector and a particle counter. The monitoring procedure of the particle monitoring systems is as such unaffected by this invention and will not be described in detail.

Incidentally, the operator of the particle monitoring system currently has to note down all related data and settings of the device for traceability reasons. Often this is done manually on a paper-based system, by manually entering data into a digital form, or by integrating the monitoring instrument or system into the operator's personal computer system or a dedicated computer system.

As all data regarding the sampling process needs to be properly and/or securely stored in a target system, the data ultimately must be transferred to such target system which could be a database, for example, a laboratory information management system (LIMS). An integration of different computer systems poses high integration effort and complex software, whereas the manual transfer from the monitoring device to a database (target system) either via a paper-based form or by direct manual input into a digital data sheet is time consuming and may lead to errors during the data transfer.

The invention aims at providing a particle monitoring system and a process of monitoring particles in a sample fluid, preferably a gas, such as air, that facilitates the transfer and transmission of data related to the sampling process to a target system.

The present invention preferably aims at providing a particle monitoring system and a process of monitoring particles in a sample, preferably a gas, such as air, that renders the transfer and transmission of data related to the sampling process to a target system more reliable and less error-prone.

### SUMMARY

To solve the problems the invention provides a particle monitoring system as defined by claim 1 and a process of monitoring particles in a sample fluid as defined by claim 11. Preferred embodiments of the system and of the process are defined in the respective dependent claims.

### BRIEF DESCRIPTION OF THE DRAWINGS

FIG. 1 is a schematic exemplary representation of a first embodiment of a particle monitoring system in the variant of a microbial air sampler with an integrated display device.

FIG. 2 is a schematic exemplary representation of a second embodiment of a particle monitoring system in the variant of a microbial air sampler which transmits the sampling related data to a secondary or external device for display via a wireless communication protocol.

### DETAILED DESCRIPTION

The invention in particular provides a particle monitoring system comprising a sampling section for performing a sampling process on a sample fluid, preferably a gas, the sampling section comprising one or both of a particle collector and a particle counter, a control section for determining, collecting and collating data regarding the sampling section and/or the sampling process, and a display device functionally linked to the control section for visualizing at least part of the data regarding the sampling section and/or the sampling process in the form of a visual, machine-readable form, preferably in the form of a bar code.

The invention also provides a process of monitoring particles in a sample fluid, the process comprising the steps of:
a) providing a particle monitoring system according to the invention;
b) performing a sampling process by flowing the sample fluid, preferably a gas, through the sampling section, the sampling process comprising one or both of collecting particles onto/into a particle collector and counting particles in a particle counter;
c) during and/or following the performance of step (b), determining, collecting and collating data relating to the sampling process of step (b) in the control section;
d) visualizing at least part of the data determined, collected, and collated in step (c) on a display device in the form of a visual, machine-readable form, preferably in the form of a bar code.

The particle monitoring system of the invention and the process of monitoring particles in a sample fluid of the invention provide, through the display device functionally linked to the control section for visualizing at least part of the data regarding the sampling section and/or the sampling process in the form of a visual, machine readable form, preferably in the form of a bar code (which may be a 1-D or 2-D bar code as an example), the possibility of displaying a configurable selection of information/data that may be gathered during the particle sampling process on the display in a graphical form.

This provides a possibility of instantaneously optically transmitting the data encoded in the visual, machine-readable form to a target system, such as a database (e.g. a LIMS), in a simple and efficient and error-safe manner using commonly available optical reading devices (scanners) with little additional software or information technology (IT) efforts for integration and without the need for either the particle monitoring system or the reading device to be connected to the target system. It also dispenses with the need to manually record the sampling related data on a paper-based form or to manually input it into a digital form with the intrinsic risk of input errors.

Preferably, in the particle monitoring system, the control section is adapted to be configured to select the data regarding the sampling section and/or the sampling process that is to be encoded in the visual, machine-readable form.

Preferably, in the particle monitoring system, the display device is integrated into a housing of the particle monitoring system, preferably in a detachable manner, and/or is implemented in the form of a software application running on an external device.

Preferably, in the particle monitoring system, the control section or, if provided, the software application running on the external device includes a section for encoding the data regarding the sampling section and/or the sampling process into the visual, machine-readable form.

Preferably, in the particle monitoring system, transfer of data between the control section and the integrated display device and/or the external device is implemented in a wireless communication protocol, preferably using radio or microwaves, for example according to the Bluetooth or WLAN standard, free-space optical communication, sonic communication or electromagnetic induction.

Preferably, in the particle monitoring system, the data regarding the sampling section and/or the sampling process includes one or more selected from the group consisting of sampling section related data, sampling process related data, instrument related data, environment related data, user related data.

Throughout this application the term “instrument” or “monitoring instrument” is used to denote any hardware component or device of the present particle monitoring system and may, for example, refer to a particle counter or collector.

Preferably, in the particle monitoring system, the sampling process related data comprises one or more selected from the group consisting of start and stop date/time, time-zone, fluid type, sampling volume, number of cycles, flow rate, number of particles, size of particles, shape of particles, surface characteristic of particles, viability of particles, characteristics of detector response of particles, and protocol number; the instrument related data comprises one or more selected from the group consisting of instrument type and serial number, firmware version, calibration date, and instrument head type; the sampling section related data comprises, for the particle collector, one or more selected from the group consisting of a particle collector provider, a particle collector type, a particle collector batch number, a particle collector production date/time, particle collector sieve type, particle collector sieve serial number, particle collector sieve autoclave date and time, particle collector location, and a particle collector expiration date/time, and, for the particle counter, one or more selected from the group consisting of particle counter provider and particle counter type; the environment related data comprises one or more selected from the group consisting of ambient temperature, ambient pressure, ambient humidity, and location identification; and the user related data comprises one or more selected from the group consisting of name, signature, birthdate, company matricule, company identification number, personnel identification number, pin number and verification of the data integrity, and hash.

Preferably, in the particle monitoring system, the particle monitoring system includes a printer configured to print the data in the visual, machine-readable form, preferably on a label.

Preferably, in the particle monitoring system, the particle monitoring system is an airborne particle counter or active air sampler or liquid particle counter or airborne molecular contamination detection system.

Preferably, in the particle monitoring system, the particle monitoring system is a mobile microbial air sampler and the detector section includes an impactor head configured to removably receive a sampling plate/dish.

Preferably, in the process of monitoring particles, the data determined, collected, and collated in step (c) is transferred between the control section and the integrated display device and/or the external device by a wireless communication protocol, preferably using radio or microwaves, for example according to the Bluetooth or WLAN standard, by free-space optical communication, by sonic communication or by electromagnetic induction.

Preferably, in the process of monitoring particles, in step c), before visualizing in step d), the data to be visualized is selected from the group consisting of sampling section related data, sampling process related data, instrument related data, environment related data, and user related data

Preferably, in the process of monitoring particles, the data determined, collected, and collated in step c) is printed in the form of the visual, machine-readable form, preferably in the form of a bar code.

Preferably, in the process of monitoring particles, the process further comprises in sequence, subsequent to step d), the steps of
e) reading the data in the visual, machine-readable form using a scanner; and
f) transferring the so-read data to a target system, for example, a laboratory information management system (LIMS).

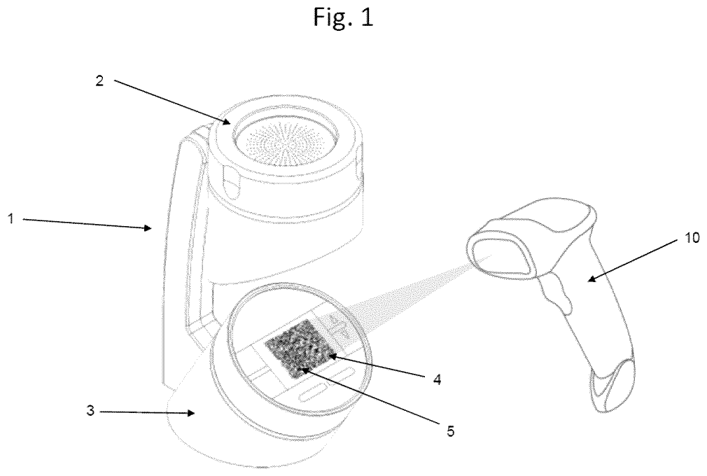

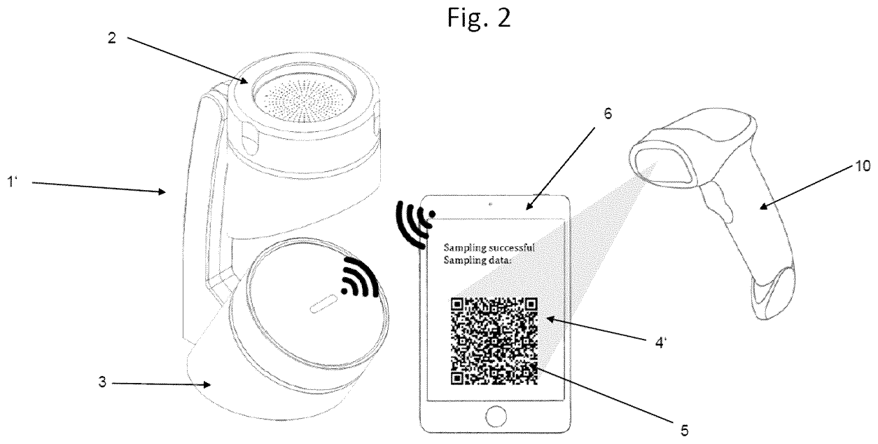

The invention is now described in detail on the basis of preferred embodiments by reference to the attached FIG. 1 and FIG. 2.

The particle monitoring system of the invention is described using two variants of a microbial air sampler 1 shown in FIGS. 1 and 2 as an example. Since the monitoring procedure of the particle monitoring systems is as such unaffected by this invention, the sampling section 2 of the particle monitoring system for performing a sampling process on a sample fluid, preferably a gas, is configured as known in the art and the sampling section may comprise one or both of a particle collector and a particle counter as described above (the sampling section 2 in the exemplary embodiments of FIGS. 1 and 2 is a particle collector).

The particle monitoring system further comprises a control section for determining, collecting and collating data regarding the sampling section and/or the sampling process (the control section may be included in a housing 3 of the system but is not shown), and a display device 4, 4′ functionally linked to the control section for visualizing at least part of the data regarding the sampling section 2 and/or the sampling process in the form of a visual, machine readable form, preferably in the form of a bar code 5. Such bar code may be, for example, any commonly known 1-D or 2-D bar code that is suitable to encode the required amount of information. The data in the visual, machine-readable form (for example the bar code 5) may then be read as desired by a commonly known optical reader or scanner 10 that is adapted to read and decode the format of the bar code and is linked to the target system and serves as an input device for the target system as is known in the art.

The display device 4 may be integrated into the housing 3 of the particle monitoring system 1 as shown in FIG. 1 and the display device may be configured as a component that is detachable from the housing 3 for the purpose of placing it at a desired alternative position in the vicinity that is more convenient to observe (not shown). In this variant the display device 4 may remain connected to the housing via a cable but a variant is feasible in which the display device is communicating the information necessary to produce the display of the data in the visual, machine-readable form via a wireless communication protocol, examples of which will be described below.

In the embodiment of FIG. 2 the display device 4′ is implemented in the form of a software application running on an external device 6 which may be in the form of a common digital computer like a mobile computer, a mobile phone, a tablet, a personal computer, an external display, a smart TV or the like device, and configured to create the display of the data in the visual, machine-readable form. The invention also comprises a configuration where the display device is integrated and the system has the function for additionally creating the display on an external device, if desired.

Depending on the configuration and setup and available computing power, the control section or, if provided, the software application running on the external device 6 includes a section for encoding the data regarding the sampling section and/or the sampling process into the visual, machine-readable form. Thus, depending on the setup, the data transferred between the control section and the integrated display device 4 and/or the external device 6 includes the uncoded data on the sampling section and/or sampling process or the coded data suitable to create the display or image in the visual, machine-readable form.

In both cases the data transfer may be made via a cable or wireless, in a wireless communication protocol, preferably using radio or microwaves, for example according to the Bluetooth or WLAN standard, free-space optical communication, sonic communication or electromagnetic induction as is known in the art.

In order to be able to display a configurable selection or set of information/data that may be gathered during the particle sampling process on the display in the graphical form, the control section is adapted to be configured to select the data regarding the sampling section and/or the sampling process that is to be encoded in the visual, machine-readable form from a number of available data items. This configuration may be implemented in the form of a software or hardware configuration and/or may be in the form of a selection menu that may be presented on the display of the system and that is set up to directly receive selections or inputs from a user (i.e. in that the display device is a touch-sensitive display) or through another input device (i.e. a keyboard or microphone for voice control or a camera for gesture detection).

The data items regarding the sampling section and/or the sampling process may typically include the data required to be documented for the sampling process and may include one or more selected from the group consisting of sampling section related data, sampling process related data, instrument related data, environment related data, user related data.

The sampling process related data, for example, may comprise one or more selected from the group consisting of start and stop date/time, time-zone, fluid type (air/gas/liquid and/or type of gas or liquid), sampling volume, number of cycles, flow rate, number of particles, size of particles, shape of particles, surface characteristic of particles, viability of particles, characteristics of detector response of particles, and protocol number.

The instrument related data may comprise, for example, one or more selected from the group consisting of instrument type and serial number, firmware version, calibration date, and instrument head type.

The sampling section related data may comprise, for example, for the particle collector if such is provided in the system, one or more selected from the group consisting of a particle collector provider, a particle collector type, a particle collector batch number, a particle collector production date/time, particle collector sieve type, particle collector sieve serial number, particle collector sieve autoclave date and time, particle collector location, and particle collector expiration date/time, and, for the particle counter, if such is provided in the system, one or more selected from the group consisting of particle counter provider and particle counter type.

The environment related data may comprise, for example, one or more selected from the group consisting of ambient temperature, ambient pressure, ambient humidity, and location identification.

Finally, the user related data may comprise, for example, one or more selected from the group consisting of name, signature (e.g. digital signature), birthdate, company matricule, company identification number, personnel identification number, pin number and verification of the data integrity (e.g. hash) of the user who has carried out or observed the sampling process.

In a variant that is not shown in detail, the particle monitoring system may include a printer configured to print the data in the visual, machine-readable form, preferably on a label. Such a printer may be a part of the system and integrated in the housing or may be a separate component of the system that is connected via a cable or again via a wireless protocol as described above.

On the level of an actual product the particle monitoring system may be an airborne particle counter or active air sampler or liquid particle counter or airborne molecular contamination detection system. In the variant of the exemplary embodiments used to describe the invention the particle monitoring system may be a mobile microbial air sampler and the detector section may include an impactor head (also known as “sieve”) configured to removably receive a sampling plate/dish.

The invention also provides a process of monitoring particles in a sample fluid that is based on providing a particle monitoring system of the invention as described above. Using the particle monitoring system, the process comprises performing a sampling process in the manner known in the art by flowing the sample fluid, preferably a gas, such as air, through the sampling section, the sampling process comprising one or both of collecting particles onto/into a particle collector and counting particles in a particle counter.

During and/or following the sampling process, the process comprises determining, collecting and collating data relating to the sampling process in the control section of the particle monitoring system. At least a part of this data is visualized on the (integrated or remote) display device in the form of a visual, machine-readable form, preferably in the form of a bar code.

As a part of the process, the data determined, collected, and collated from the sampling section and/or sampling process is transferred between the control section and the integrated display device and/or the external device/display device by a wireless communication protocol, preferably using radio or microwaves, for example according to the Bluetooth or WLAN standard, by free-space optical communication, by sonic communication or by electromagnetic induction.

In order to display a configurable selection of information/data that may be gathered during the particle sampling process on the display in the graphical form, the process preferably comprises, before visualizing the data, selecting the data items to be visualized from the group consisting of sampling section related data, sampling process related data, instrument related data, environment related data, and user related data as described above. The information to be selected within each of these categories of information may be the same as that described above in connection with the system.

In addition to displaying the data on the display device, the data determined, collected, and collated may be printed in the form of the visual, machine-readable form, preferably in the form of a bar code. In this form the printout can be used to enter the data into the target system in a more remote location and/or may be stored and kept as a backup. In the form of a printout the data is also protected against accidental or intended subsequent manipulation of the data or of parts of it.

In order to enter the data into the target system, the process may thus also comprise a step of reading the data in the visual, machine readable-form (from the display or from the printout) using a scanner or another suitable optical reader, and optionally transferring the so-read data to a database, for example, a laboratory information management system (LIMS) which is an example of a target system.

1. A particle monitoring system (1;1′) comprising:
a sampling section (2) for performing a sampling process on a sample fluid, preferably a gas, the sampling section (2) comprising one or both of a particle collector and a particle counter;
a control section for determining, collecting and collating data regarding the sampling section and/or the sampling process; and
a display device (4;4′) functionally linked to the control section for visualizing at least part of the data regarding the sampling section and/or the sampling process in the form of a visual, machine-readable form, preferably in the form of a bar code (5).

2. The particle monitoring system (1;1′) according to claim 1, wherein the control section is adapted to be configured to select the data regarding the sampling section and/or the sampling process that is to be encoded in the visual, machine-readable form.

3. The particle monitoring system (1;1′) according to claim 1, wherein the display device (4;4′) is integrated into a housing (3) of the particle monitoring system (1;1′), preferably in a detachable manner, and/or is implemented in the form of a software application running on an external device (6).

4. The particle monitoring system (1;1′) according to claim 1, wherein the control section or, if provided, the software application running on the external device (6) includes a section for encoding the data regarding the sampling section and/or the sampling process into the visual, machine-readable form.

5. The particle monitoring system (1;1′) according to claim 3, wherein transfer of data between the control section and the integrated display device (4) and/or the external device (6) is implemented in a wireless communication protocol, preferably using radio or microwaves, for example according to the Bluetooth or WLAN standard, free-space optical communication, sonic communication or electromagnetic induction.

6. The particle monitoring system (1;1′) according to say. claim 1, wherein the data regarding the sampling section and/or the sampling process includes one or more selected from the group consisting of:
sampling section related data, sampling process related data, instrument related data, environment related data, user related data.

7. The particle monitoring system (1;1′) according to claim 6, wherein the sampling process related data comprises one or more selected from the group consisting of start and stop date/time, time-zone, fluid type, sampling volume, number of cycles, flow rate, number of particles, size of particles, shape of particles, surface characteristic of particles, viability of particles, characteristics of detector response of particles, and protocol number;
wherein the instrument related data comprises one or more selected from the group consisting of instrument type and serial number, firmware version, calibration date, and instrument head type;
wherein the sampling section related data comprises, for the particle collector, one or more selected from the group consisting of a particle collector provider, a particle collector type, a particle collector batch number, a particle collector production date/time, particle collector sieve type, particle collector sieve serial number, particle collector sieve autoclave date and time, particle collector location, and a particle collector expiration date/time, and, for the particle counter, one or more selected from the group consisting of particle counter provider and particle counter type;
wherein the environment related data comprises one or more selected from the group consisting of ambient temperature, ambient pressure, ambient humidity, and location identification; and
wherein the user related data comprises one or more selected from the group consisting of name, signature, birthdate, company matricule, company identification number, personnel identification number, pin number and verification of the data integrity, and hash.

8. The particle monitoring system (1;1′) according to claim 1, wherein the particle monitoring system includes a printer configured to print the data in the visual, machine-readable form, preferably on a label.

9. The particle monitoring system (1;1′) according claim 1, wherein the particle monitoring system is an airborne particle counter or active air sampler or liquid particle counter or airborne molecular contamination detection system.

10. The particle monitoring system (1;1′) according to claim 9, wherein the particle monitoring system is a mobile microbial air sampler and the detector section includes an impactor head configured to removably receive a sampling plate/dish.

11. A process of monitoring particles in a sample fluid, the process comprising the steps of:
a) providing a particle monitoring system as defined in claim 1;
b) performing a sampling process by flowing the sample fluid, preferably a gas, through the sampling section, the sampling process comprising one or both of collecting particles onto/into a particle collector and counting particles in a particle counter;
c) during and/or following the performance of step (b), determining, collecting and collating data relating to the sampling process of step (b) in the control section;
d) visualizing at least part of the data determined, collected, and collated in step (c) on a display device in the form of a visual, machine-readable form, preferably in the form of a bar code.

12. The process of monitoring particles according to claim 11, wherein the data determined, collected, and collated in step (c) is transferred between the control section and the integrated display device and/or the external device by a wireless communication protocol, preferably using radio or microwaves, for example according to the Bluetooth or WLAN standard, by free-space optical communication, by sonic communication or by electromagnetic induction.

13. The process of monitoring particles according to claim 11, wherein in step c), before visualizing in step d), the data to be visualized is selected from the group consisting of sampling section related data, sampling process related data, instrument related data, environment related data, and user related data

14. The process of monitoring particles according to claim 11, wherein the data determined, collected, and collated in step c) is printed in the form of the visual, machine-readable form, preferably in the form of a bar code.

15. The process of monitoring particles according to claim 11, said process further comprising in sequence, subsequent to step d), the steps of
e) reading the data in the visual, machine-readable form using a scanner; and
f) transferring the so-read data to a target system, for example, a laboratory information management system (LIMS).
